(19) United States
(12) Patent Application Publication
(10) Pub. No.: US 2012/0192830 A1
(43) Pub. Date: Aug. 2, 2012

(54) INTERNAL COMBUSTION ROTARY PISTON ENGINE

(75) Inventor: Mansour Almassi, Earth Perth (AU)

(73) Assignee: Are Engines Limited, Winthrop (AU)

(21) Appl. No.: 13/392,633

(22) PCT Filed: Sep. 1, 2009
(86) PCT No.: PCT/AU2009/001138

§ 371 Date: Mar. 27, 2012

(30) Foreign Application Priority Data
Sep. 1, 2008 (AU) 2008904518

(51) Int. Cl. F02B 53/00; F16C 19/04

(52) U.S. Cl. 123/200; 384/490

(57) ABSTRACT

An internal combustion rotary piston engine includes a cylinder housing a power piston and a second piston which is coupled to the power piston. A shaft is coaxially supported in the cylinder and is able to rotate along a longitudinal axis that is fixed from translational motion along the axis. The pistons are mounted on the shaft in a manner where they can reciprocate along a shaft and rotate with a shaft. A track and bearing system couples the second piston to the cylinder and is configured to cause the second piston and thus the piston and shaft to rotate as the piston reciprocates along the shaft. The track of the track and bearing system is formed with a radius which is greater than the radius of the power piston. The torque produced by the engine can be varied by varying the radius of the track.

### Field of the Invention

The invention relates to an internal combustion rotary piston engine.

### BACKGROUND OF THE INVENTION

In most internal combustion engines a complete combustion cycle comprises the four steps of:
(a) providing a fuel/air mixture into a combustion chamber of a cylinder;
(b) compressing the mixture;
(c) combusting the mixture; and
(d) exhausting the products of the combustion from the cylinder.

Two systems for accomplishing these operations comprise, the four stroke cycle, in which one step takes place during each stroke of a piston in the cylinder; and, the two stroke cycle, in which two of the above steps are accomplished in each stroke of the piston.

In a conventional four stroke reciprocating engine where the pistons are attached to a crank-shaft, each stroke requires a 180° rotation of the crank shaft. Thus one complete cycle requires a crank-shaft rotation of 720° equating to two full turns of the crank-shaft. Energy is created by the engine during the combustion or power stroke of the piston. This energy is stored in a fly wheel coupled to the crank-shaft which in turn provides sufficient energy to rotate the pistons through the next three strokes to the subsequent power stroke.

A two stroke engine is more efficient in that all four of the abovementioned steps are carried out in two strokes of the piston and a 360° rotation of the crank-shaft, equating to one turn of the crank-shaft. That is the two stroke engine provides twice as many power strokes per crank-shaft revolution as four stroke. This arises because in a two stroke engine a fresh charge of fuel and air is compressed below the power piston and then forced into the cylinder when the piston is at the bottom of its stroke. The fresh charge of fuel and air in the cylinder partially helps to sweep the remaining exhaust gases from the cylinder. The mixed fuel and air charge is then compressed during the compression stroke of the piston and ignited when the piston reaches top dead centre. This causes the piston to commence the power stroke where it moves toward bottom dead centre.

The advantages of the two stroke being a greater number of power strokes per revolution, mechanical simplicity and lightness are offset by fuel inefficiency and increased pollution. If the fuel/air charge is of the same volume as would be required by a comparable four stroke, the two stroke engine would not sweep out exhaust gases completely, thereby reducing the power developed on the next power stroke since a percentage of the charge includes exhaust gases from the previous cycle. In addition the power stroke is shorter as exhaust gases are expelled during a portion of the downstroke. The increased pollution in the two stroke engine arises as lubricant, namely oil is added to the fuel in order to lubricate the cylinder wall. The oil in the fuel mixture is burnt during the power stroke leading to high exhaust emission levels and fouling of the engine.

### SUMMARY OF THE INVENTION

One aspect of the present invention provides a four stroke internal combustion rotary piston engine comprising:
at least one cylinder, each cylinder having a respective longitudinal axis;
a shaft supported coaxially in each cylinder wherein the shaft is axially fixed and rotatable about the longitudinal axis;
a power piston supported on the shaft, wherein the power piston is able to reciprocate along the longitudinal axis and is rotationally fixed relative to the shaft; and
a coupling system for coupling the power piston to the cylinder, the coupling system causing the power piston and the shaft to rotate together about the longitudinal axis as the piston reciprocates along the shaft;
wherein the engine operates on a four stroke cycle comprising an induction stroke, a compression stroke, a power stroke and an exhaust stroke with respective sequential reciprocations of the power piston along the shaft.

A second aspect of the invention provides an internal combustion rotary piston engine comprising:
at least one cylinder having a longitudinal axis;
a power piston and a second piston retained in each cylinder, the power piston and second piston being fixed to each other;
a shaft supported coaxially in the cylinder wherein the shaft is rotatable about the longitudinal axis and fixed from translational motion along the longitudinal axis, wherein torque provided by the engine is output through the shaft;
the power piston and second piston mounted on the shaft wherein the power piston and second piston can reciprocate along the longitudinal axis and are rotationally fixed relative to the shaft; and,
a track and a bearing system coupling the second piston to the cylinder wherein as the second piston reciprocates the bearing system engages the track to cause rotation of the second piston and the shaft about the longitudinal axis, wherein the track has a radius greater than a radius of the power piston.

The engine may be configured to operate on a four stroke cycle comprising an induction stroke, a compression stroke, a power stroke and an exhaust stroke with respective sequential reciprocations of the power piston along the shaft.

In a first embodiment the four stroke cycle is completed with a 360 degree rotation of the shaft. In this embodiment during the power stroke the power piston and the shaft rotate by 90 degrees about the longitudinal axis. In this embodiment, the power piston may also rotate by 90 degrees during each of the induction, compression and exhaust strokes.

In one form of this embodiment the power stroke has a period Pp, and the exhaust stroke has a period Pe wherein Pp>Pe. Similarly, the induction stroke has a period Pi and a compression stroke has a period Pc wherein Pi>Pc. The engine may be further configured so that Pp equals Pi and Pe equals Pc.

The engine further comprises a second piston disposed in each cylinder and mounted on the shaft of that cylinder, the second piston fixed to the power piston and mounted to reciprocate along the longitudinal axis, the second piston being rotationally fixed relative to the shaft.

The coupling system may comprise either (a) an endless track formed about an outer circumferential surface of the second piston and a bearing system supported by the cylinder that engages the track, or (b) an endless track formed on a inner circumferential surface of the cylinder and a bearing system supported by the second piston that engages the track.

In either of the above configurations of the coupling system, the second piston and track may have a different outer diameter than an outer diameter of the power piston.

The engine may further comprise a lubrication system which distributes a lubricant to an interior of the cylinder, the lubricant system comprising a passage extending axially within the shaft, the passage providing a fluid communication path between a supply of lubricant and the interior of the cylinder.

The lubrication system may further comprise a lubricant piston disposed in the passage, the lubricant piston coupled to the power piston and reciprocating in the passage as the power piston reciprocates in the cylinder. A lubricant outlet is provided at an end of the passage opening onto an outer circumferential surface of the power piston and to cylinder walls.

The cylinder may comprise a compression region located between the second piston and an end of the cylinder distant the power piston; and a first fluid flow path providing fluid communication between the compression region and a combustion chamber enabling fluid compressed in the compression region during a down stroke of the second piston to flow to the combustion chamber.

The engine may comprise a first inlet to the first fluid flow path wherein fluid from the first inlet flows through the first fluid path to the compression region during an upstroke of the piston.

The fluid may air or a fuel and air mixture.

A first one way valve is provided for controlling induction of fluid into the compression region wherein during an upstroke of the power piston a relative of vacuum is created in the compression region to open the first one way valve and induct the fluid into the compression region, and wherein on a downstroke of the power piston, the second piston compresses the fluid and creates a relative positive pressure closing the first one way valve.

A second one way valve is provided for controlling flow of compressed fluid from the compression region to the combustion chamber, wherein the second one way valve closes when the power piston travels in an upstroke and opens during a downstroke of the power piston.

The cylinder may comprise:
a cooling region between the power piston and the second piston and, a port in the cylinder enabling a gas to flow, into the cooling region during a downstroke of the power piston and, out of the cooling region during an upstroke of the power piston.

The engine may comprise a second fluid flow path between the port and an exhaust manifold wherein the gas flowing out of the cooling region can flow through the second flow path into the exhaust manifold.

A third one way valve is provided for controlling flow of the gas into the cooling region, the third one way valve opening during a downstroke of the power piston to induct a flow of the gas into the cooling region to cool the cylinder and power piston.

A fourth one way valve is provided in the second fluid flow path and which opens during a upstroke of the power piston and closes during an downstroke of the power piston, the fourth one way valve opening the second fluid flow path between the cooling region and an exhaust wherein the gas previously inducted in the cooling region is exhausted to the exhaust manifold.

A further aspect of the present invention provides a bearing system comprising:

a primary ball bearing and a plurality of secondary ball bearings on which the primary ball bearing sits; and,

a spacer system for spacing the secondary ball bearings from each other;

wherein the primary ball bearing has a radius greater than a radius of the secondary ball bearings.

The spacer system may comprise a plurality of tertiary ball bearings wherein the tertiary ball bearings have a radius less than a radius of the secondary ball bearings.

The ball bearing system further comprises a cup having a bearing surface on which the secondary ball bearings run.

In one embodiment, the tertiary ball bearings are located between respective secondary ball bearings on a side adjacent to the bearing surface. In an alternate embodiment, the tertiary ball bearings are disposed between adjacent secondary ball bearings on a side opposite the bearing surface and adjacent to the primary ball bearing. In yet a further variation the plurality of tertiary ball bearings may comprise first and second sets of tertiary ball bearings wherein the first set of tertiary ball bearings are disposed on a side of the secondary ball bearings adjacent the bearing surface and a second set of the tertiary ball bearings are disposed on a side of the secondary ball bearings adjacent the primary ball bearings.

### BRIEF DESCRIPTION OF THE DRAWINGS

An embodiment of the present invention will now be described by way of example only with reference to the accompanying drawings in which:

FIG. 1 is a schematic representation of an engine in accordance with an embodiment of the present invention;

FIG. 2 is a section view of a bearing incorporated in the engine;

FIG. 3 is a development of a track incorporated in a piston used in the internal combustion engine;

FIG. 4 is a development of an alternate configuration of track formed in a piston of the internal combustion engine;

FIG. 5 is a view of section AA of a shaft shown in FIG. 1; and,

FIG. 6 is a development of a possible track configuration for a further embodiment of the engine.

### DETAILED DESCRIPTION OF PREFERRED EMBODIMENTS

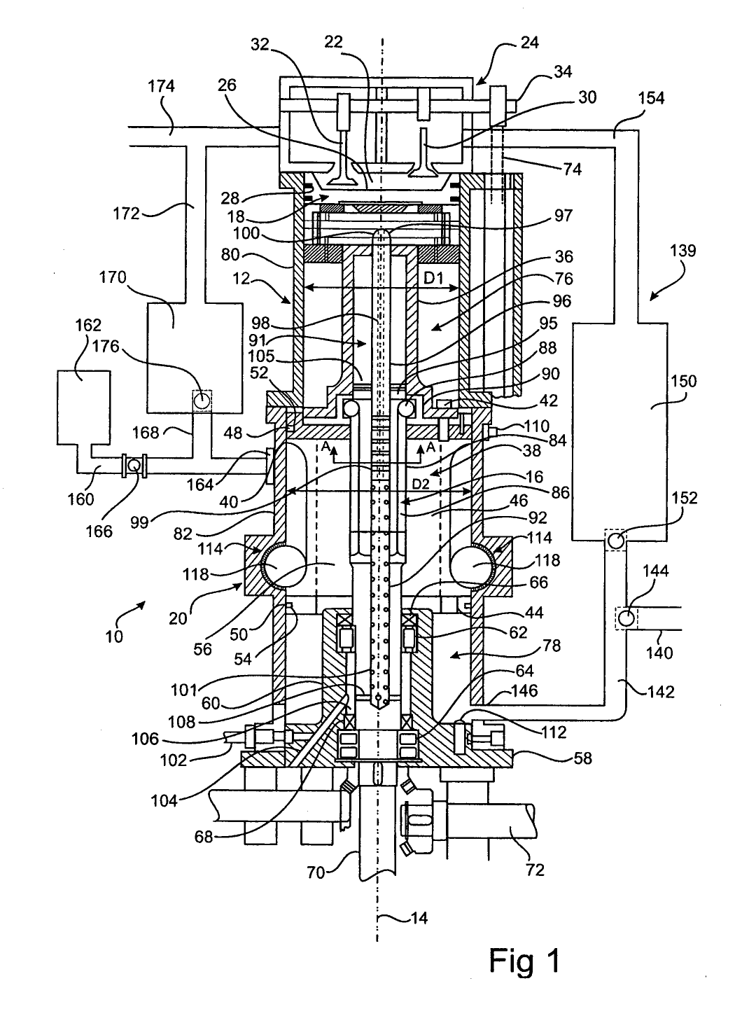

Referring to the accompanying drawings and in particular FIG. 1, an embodiment of an internal combustion rotary piston engine 10 in accordance with the present invention comprises a cylinder 12 having a longitudinal axis 14, a shaft 16, a power piston 18 supported on the shaft 16 and a coupling system 20 for coupling the power piston 18 to the cylinder 12. The shaft 16 is co-axially supported in the cylinder 12 and fixed from translational motion in the axial direction. However, the shaft 16 is able to rotate about the longitudinal axis 14.

The piston 18 is supported on the shaft 16 in a manner where it is able to reciprocate along the shaft in the direction of the longitudinal axis 14 and is rotationally fixed relative to the shaft 16. The coupling system 20 couples the piston 18 to the cylinder 12 in a manner which causes the piston 18 and the shaft 16 to rotate together about the longitudinal axis 14 as the piston 18 reciprocates along a shaft 16. Thus as the piston 18 travels in either an upstroke or a downstroke within the cylinder 12, it is caused to rotate in the same direction within the cylinder 12 about the longitudinal axis 14. This rotary motion is imparted to the shaft 16 which may either directly or indirectly via an arrangement of gears, rotate a fly wheel (not shown). Thus the torque produced by the engine 10 is output via the shaft 16.

The engine 10 operates in a 4-stroke cycle comprising an induction stroke, a compression stroke, a power stroke and an exhaust stroke with respective sequential reciprocations of the power piston 18 along a shaft 16. As explained in greater detail below, the 4-stroke cycle may be completed with a 360° rotation of the shaft 16. A combustion chamber 22 is formed at a top end of the cylinder 12 between a cylinder head 24 bolted to the cylinder 12 and an upper surface 26 of piston head 28 of the piston 18. The cylinder head 24 is provided with one or more inlet valves 30 and one or more outlet valves 32, each of the valves being operated by a cam shaft 34. As explained in greater detail below, the cam shaft 34 is driven by the shaft 16. The configuration and operation of the head 24 is not essential to the invention, and a conventional cylinder head may be used with embodiments of the invention.

The piston 18 is coupled by a tubular connecting rod 36 to a second piston 38 also housed within the cylinder 12. The piston 18 has a diameter D1 which is smaller than a diameter D2 of the second piston 38. The second piston 38 has an upper circular head 40 that is attached to the connecting rod 36 by bolts 42 and a lower annular ring 44 spaced from and coupled to the head 40 by a circumferential skirt 46. Sealing rings 48 and 50 are seated in respective grooves 52 and 54 formed in an outer circumferential surface of the head 40 and the annular ring 44 respectively. A cavity 56 is formed in the second piston 38 inside of the skirt 46 between the head 40 and the ring 44.

An end of the cylinder 12 opposite the head 24 is closed by a main bearing housing 58 which is provided with an axially extending boss 60 that protrudes into the cylinder 12.

The shaft 16 extends through the boss 60 and is supported in bearings 62 and 64. In order to maintain compression within the cylinder 12, seals 66 and 68 are fitted between the outer surface of the shaft 16 and an inner circumferential surface of the boss 60 at locations adjacent the bearings 62 and 64 on a side facing the piston 18.

An end 70 of the shaft 16 extending from the cylinder 12 is coupled either directly or, more commonly in a multi cylinder engine, via a gear arrangement (now shown), to a fly wheel. Additionally, the end of the shaft 70 is coupled to a timing shaft 72 which drives a timing chain 74 coupled to the cam shaft 34. The timing shaft 72 may further be coupled to a starter motor (not shown) of the engine 10. The timing shaft 72, or indeed an alternate shaft driven by the end 70 of shaft 16, maybe coupled to power other devices or systems of the engine such as an oil pump, water pump or alternator.

The piston 18 and second piston 38 divide the cylinder 12 into a first region 76 and a second region 78. The first region 76 lies between the piston head 28 and the upper head 40 and is bound on its sides by the inner circumferential wall of the cylinder 12. The second region 78 is defined between the head 40 and the bottom of the main bearing housing 58 and includes the cavity 56 defined by the second piston 38. The first and second regions 76 and 78 cyclically vary in volume as the piston 18 reciprocates within the cylinder 12.

The cylinder 12 comprises contiguous first and second portions 80 and 82. The first portion 80, which is adjacent the cylinder head 24, has a diameter which is marginally greater than the diameter D1 of the piston head 24. During reciprocation of the piston 18, the piston head 24 always remains within the portion 80 of the cylinder 12 while the second piston 38 always remains within the second portion 82. The portion 82 has a diameter that is marginally greater than the diameter D2 of piston 38.

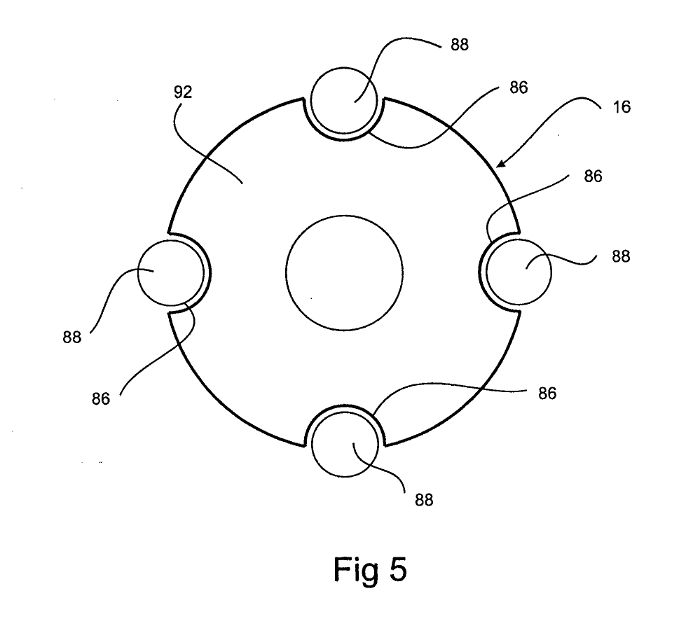

A length 84 of the shaft 16 that lies inside the cylinder 12 is provided with a plurality of longitudinally extending flutes of grooves 86. As shown in FIG. 5, the flutes or grooves 86 are formed with a semi circular profile. The piston 18 is coupled to the shaft 16 by engagement of a plurality of ball bearings 88 which are retained in a race 90 held between the connecting rod 36 and the head 40. The ball bearings 88 extend by a distance approximately equal to their radius from the race 90 into the grooves or flutes 86. By virtue of this arrangement, the connecting rod 36 and thus the piston 18 is able to reciprocate along the shaft 16 while being rotationally locked to the shaft 16.

The engine 10 is provided with a lubrication system 91 that comprises a passage 92 formed in the shaft 16 and a lubricant piston 96 that reciprocates in the passage 92. The passage 92 is formed as a hole extending axially from an upper end 95 of the shaft 16 and terminating in the shaft 16 at a location within the cylinder 12 between the bearings 62 and 64.

The piston 96 is in the form of a rod which is attached at one end 97 to the piston head 24 and extends axially through the connecting rod 36 into the passage 92 terminating at a distal end 99. Optionally a compression coil spring 101 is seated at the bottom of the passage 92 and biases the piston 96 in a direction toward the cylinder head 24. A gallery 98 is formed along a central axis of the piston 96 and communicates at the end 97 with oil distribution galleries 100. An opposite end of the gallery 98 opens onto the distal end 99 of the piston 96. As the piston 18 reciprocates, the rod 96 reciprocates within the passage 92, forming in effect a lubricant pump for the engine 10.

Oil for lubricating the engine 10 is supplied via an oil inlet valve 102 which extends radially into the main bearing housing 58 and communicates with a diagonally extending gallery 104. The gallery 104 leads at one end to a region 106 within the boss 60 between the bearings 62 and 64. Further oil galleries 108 are provided in a portion of the shaft 16 located in the region 106. The galleries 108 extend radially from an outer surface of the shaft 16 to the passage 92. Thus when oil is delivered through the oil inlet valve 102 it is able to flow through the gallery 104 into the region 106 and subsequently via the galleries 108 into the passage 92. The reciprocating motion of the lubricant piston 96 within the passage 92 provides a pumping effect to pump the oil up through the gallery 98 to be distributed through the galleries 100 to lubricate the inner surface of the cylinder 12. One way oil return valves 110 and 112 are provided in the cylinder 12 to allow the draining of lubricant oil to a sump (not shown).

A seal 105 is located about the lubricant piston 96 adjacent the race 90. The seal 105 together with the sealing rings 52 act to seal region 76 from region 78.

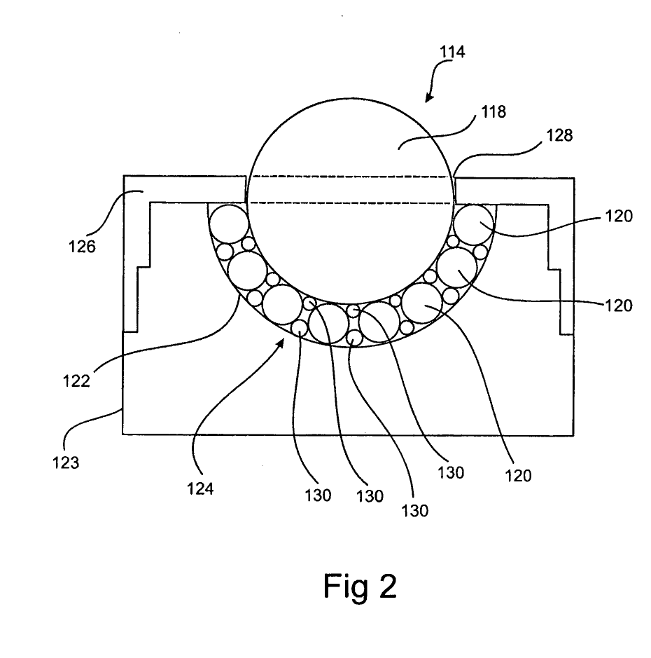

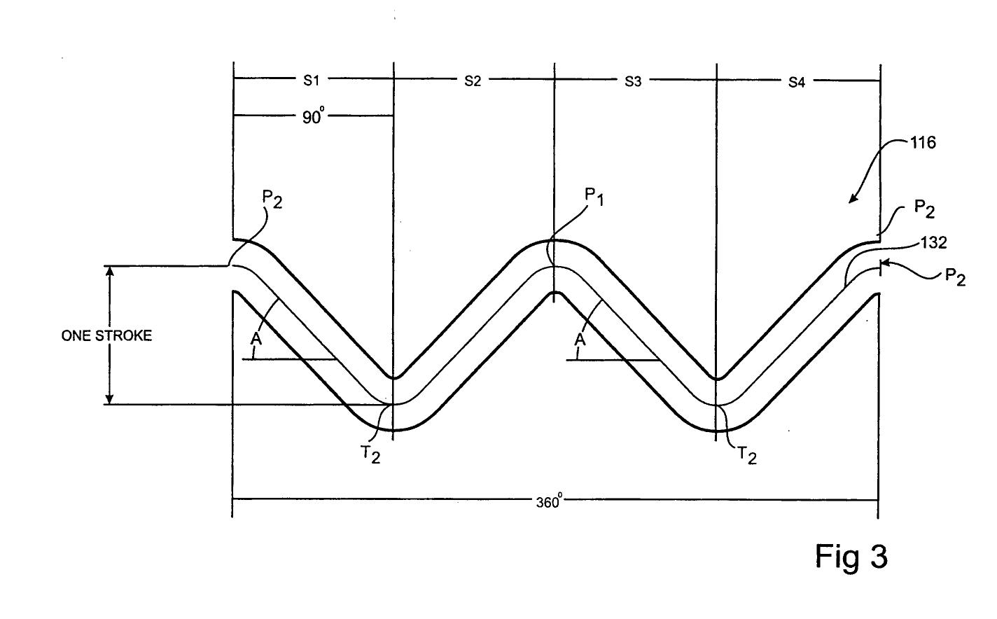

With particular reference to FIGS. 1 and 2, the coupling system 20 comprises the combination of bearing systems 114 and a track 116. In this particular embodiment, each bearing system 114 is supported by the second cylinder portion 82 while the track 116 is formed on an outer circumferential surface of the second piston 38. One possible configuration of the track 116 is depicted in FIG. 3.

Each bearing system 114 engages the track 116 and, due to the configuration of the track 116 causes rotation of the second piston 38 and thus the piston 18, the shaft 16 and piston rod 36, as the ensemble of the pistons 18 and 38 reciprocate along the shaft 16.

Each bearing system 114 comprises a primary ball bearing 118 and a plurality of secondary ball bearings 120 on which the primary ball bearing 118 sits. The secondary ball bearings 120 form a layer on a hemispherical bearing surface 122 of a bearing block 123. A spacer system 124 is provided in the bearing system 114 to space the secondary ball bearings 120 from each other. Thus, the spacer system 124 maintains physical separation between adjacent secondary ball bearings 120.

An over centre locking flange 126 having a central hole 128 is fastened to the bearing block 123. A portion of the primary ball bearing 118 extends through the hole 128 in the flange 126. The hole 128 has a minimum radius smaller than the radius of the primary ball bearing 118 and is located on a side of the centre of the primary ball bearing 118 distant the bearing block 123 thus retaining the primary ball bearing 118 in the block 123.

In this embodiment, the spacer system 124 comprises a plurality of tertiary ball bearings 130 which have a radius smaller than the radius of the secondary ball bearings 120 and are located between respective secondary ball bearings 120.

Tertiary ball bearings 130 may be located on a side of the ball bearings 120 adjacent the bearing surface 122. In an alternate configuration, the tertiary ball bearings 130 may be located between the secondary ball bearings 120 on a side adjacent the primary ball bearing 118. In a further configuration, the tertiary ball bearings 130 may be provided between adjacent secondary ball bearings 120 on both a side adjacent the bearing surface 122 and on a side adjacent the primary bearing 118.

In one embodiment, the primary ball bearing 118 may have a diameter in the order of 32 mm, the secondary ball bearings 120 a diameter of approximately 7 mm and the tertiary ball bearings a diameter of approximately 2.73 mm.

As a result of the primary ball bearing 118 being supported on the secondary ball bearings 120 which in turn are spaced apart by the spacer system 124/tertiary ball bearings 130, the primary ball bearing 118 is able to roll about any axis passing through its centre with minimal friction.

FIG. 3 depicts one embodiment of a track 116 which follows a sinusoidal path. The track 118 forms a closed or endless loop. In this regard FIG. 3 merely represents the track formed about the circumferential surface of the skirt 46 when laid out flat. Thus, on the second piston 38 opposite ends of the track shown in FIG. 3 join to each other.

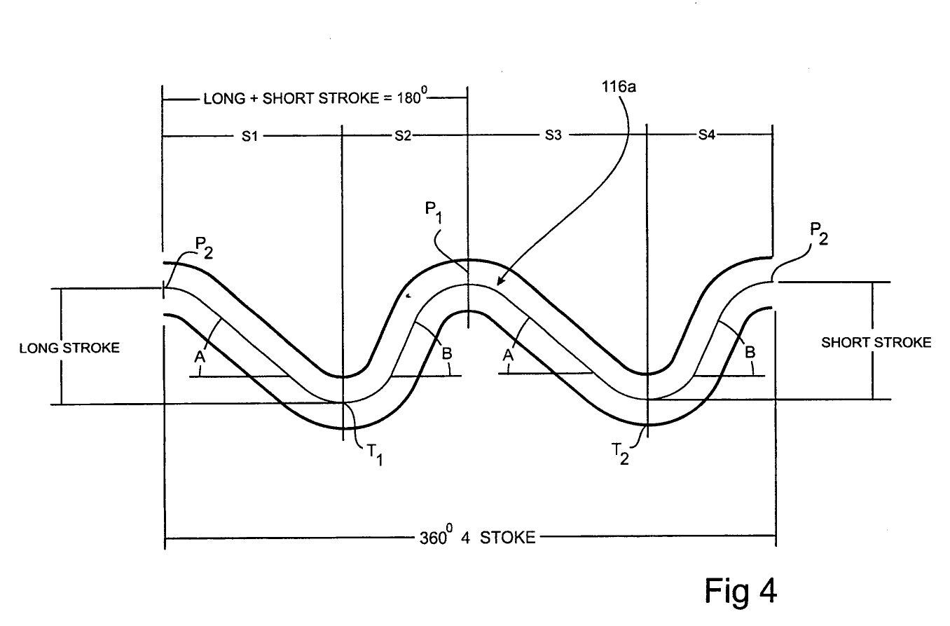

The track 116 is of a generally sinusoidal shape and has a semicircular profile of a radius marginally greater than the radius of the primary ball bearing 118. Line 132 represents a centre line of the track 116. The track 116 comprises a first peak P1, two troughs T1 and T2 on opposite sides of the peak P1 and a second peak P2. As opposite ends of the track 116 join each other to form a continuous loop, the peak P2 represented on the left and right hand sides of the track 116 shown in FIG. 4 are one and the same.

On the second piston 38, the peaks P1 and P2 are diagonally opposed as are the troughs T1 and T2. Thus, there is a 180° rotation of the second piston 38 between the peaks P1 and P2 and similarly a 180° rotation between the troughs T1 and T2. More particularly, there is a 90° rotation between respective adjacent peaks and trough. The bearing system 114 engage the track 116 at diametrically opposed locations. While the primary ball bearings 118 are able to rotate about any axis passing through their respective centres, they are fixed from translational motion in a direction parallel to the axis 14. Thus as the piston 18 and consequently the second piston 38 reciprocate, the engagement of the track 116 with the bearing system 114 causes rotation of the second piston 38, piston 18, shaft 16 and piston rod 36.

The length of the stroke of the piston 18, that is the distance between top dead centre (TDC) and bottom dead centre (BDC) is equal to the transverse distance A between an adjacent peak P and trough T. This distance is traversed in a 90° rotation of the second piston 38. For the track 116, each successive peak and trough is rotationally spaced by 90°. The rotation of the second piston 38 from P2 to T1 corresponds to a first stroke S1 of the piston 18. The next 90° rotation of the second piston 38 from T1 to P1 corresponds to a second stroke S2 of the piston 18. The next 90° rotation of the second piston 38 corresponds to a third stroke S3 of the piston 18, while the next 90° rotation of the second piston 38 corresponds to a fourth stroke S4 of the piston 18. Thus, as the piston 38 rotates one complete revolution (ie, 360°) the piston 18 undergoes four strokes within the cylinder 12. With the track 116 illustrated in FIG. 3, strokes S1 and S3 are upstrokes which in the four stroke cycle corresponds compression and exhaust strokes, while strokes S2 and S4 are downstrokes corresponding power and induction strokes respectively.

As explained in greater detail below, the second piston 38 in effect acts as a crank-shaft for the engine 10. In a conventional combustion engine, the stroke length, that is the distance between TDC and BDC, is equal to diameter of the crank shaft. In the present engine 10, the stroke length, as explained above is determined by the transverse distance A between an adjacent peak P and trough T of the track 116. In a conventional engine, the number of turns of the crank-shaft required to complete all four strokes is fixed at two rotations or 720° . However in the engine 10, the number of rotations of the second piston 38 required to complete all four strokes can be varied by varying the configuration of the track 116. In the embodiment of FIG. 3, only a single 360° rotation of the second piston 38 is required to complete all four strokes. Further, in a conventional internal combustion engine, the torque produced is dependent upon mean cylinder pressure and a variable length lever arm being the transverse distance from the crank shaft axis of rotation to point where a con rod connects to the crank-shaft. In the engine 10, the equivalent “lever arm” is the radius R2 of the second piston 38. Thus torque produced can be varied by varying the diameter of the piston 38. Moreover the degree of rotation per stroke can be varied by varying the configuration of the track 116. Indeed it is possible to configure the track 116 so that one of the upstrokes and downstrokes are quicker than the other ie, the degree of rotation of the second piston 38 to complete an upstroke or downstroke can be made less than the degree of rotation required for a downstroke or upstroke respectively.

With reference to FIG. 1, fluid flow path 139 provides fluid communication between the second region 78 and the combustion chamber 22. The flow path 139 comprises conduit 142, valve 152, accommodator 150 and conduit 154. A fuel and air mixture is provided by a conduit 140 which is coupled to the conduit 142 via the one way valve 144 which allows a flow of fluid in the direction from conduit 140 into conduit 142. The conduit 142 is coupled at a lower end to a port 146 which is in fluid communication with the second region 78 of the cylinder 12. An opposite end of the conduit 142 leads to an accumulator 150 via a one way valve 152 which allows a flow of fluid in a direction from the conduit 142 to the accumulator 150. The accumulator 150 is in fluid communication with an intake manifold 154 to provide fuel/air mixture to the inlet valve 30.

Gas in the form of fresh air is provided to the first region 76 via a conduit 160. The conduit 160 is in communication at one end with an air filter 162 and at an opposite end to an inlet port 164 on the portion 82 of the cylinder 12. A one way valve 166 is disposed in the conduit 160 to enable a flow of air in a direction from the air filter 162 to the port 164. The port 164 is also plumbed via a conduit 168 to an accumulator 170 which in turn is in fluid communication via a conduit 172 to an exhaust manifold 174. A one way valve 176 controls fluid communication between the conduit 168 and the accumulator 170 allowing fluid flow only in a direction from the conduit 168 to the accumulator 170.

An operating cycle of the engine 10 will now be described. Assume in a starting position, that the piston 18 is at top dead centre. This corresponds with the bearing system 114 and in particular the primary ball bearings 118 being seated in the track 116 at the troughs T1 and T2 shown in FIG. 3. Also assume at this time that the next stroke to be undertaken by the engine 10 is an induction stroke and that the accumulator 150 is charged with an air/fuel mixture and that the shaft 16 is coupled to a rotating fly wheel.

As the induction stroke commences, pistons 18 and 38 commence their downward stroke within the cylinder 12. The valve 30 is opened by action of the camshaft 34 which is driven by a timing chain 74 connected to the shaft 72 which in turn is driven by the shaft 16. As this occurs, a relative vacuum is created in the first region 76 between the pistons 18 and 38 arising from the effective increases in volume of this region as the piston 38 moves downwardly within the larger diameter portion 82 of the cylinder 12. This action has the effect of opening the one way valve 166 and closing the one way valve 176. Thus cool air initially at ambient temperature passes through the filter 162, the conduit 160, the valve 166 and into the region 76 and upper part of region 82. This provides air cooling to the engine 10 as well as cooling to the lubricant oil pumped into the engine 10 via the lubrication system. Also, during this downstroke, the volume of the region 78 decreases causing an increase in pressure in a fuel/air mixture previously charged into the region 78. This increase in pressure is communicated via the conduits 146 and 142 to the valves 144 and 152. This closes the one way valve 144 and opens the one way valve 152 so that a compressed fuel/air mixture is charged into the accumulator 150. The inlet valve 30 is open by action of the cam shaft 34 allowing a fuel/air charge to be inducted into the combustion chamber 22.

At the bottom of the induction stroke piston 18 is at BDC and the primary ball bearings 118 are seated at the peaks P1 and P2 of the track 116. As a result of the connection of the shaft 16 to a flywheel (not shown) the shaft 16 and thus the second piston 18 continue to rotate about the axis 14. The track 116 rides up the primary ball bearings 118 as the second piston 38 rotates thus causing the upward stroke of the piston 18 to commence. During this stroke, the fuel/air charge previously admitted into the combustion chamber 22 is compressed via the piston 18. Further, the volume of the region 76 now decreases causing an increase in pressure in the fresh air previously charged into the region 76. This increase in pressure closes the one way valve 166 but opens the one way valve 176. Thus the air previously inducted into the region 76 for cooling of the engine is now caused to flow through the conduit 168 into the accumulator 170.

Simultaneously, the volume of the region 78 increases creating a relative vacuum in that region. This has the effect of opening the one way valve 144 and closing the one way valve 152. Thus, a fresh charge of fuel/air mixture is inducted into the region 78. During the compression stroke both the inlet valve 30 and exhaust valve 32 are closed.

Eventually, the piston 18 reaches top dead centre corresponding with the primary ball bearings 118 now being located at the troughs T1 and T2 and the track 116. Due to the momentum of the fly wheel, the shaft 16 and thus the pistons 18 and 38 continue to rotate. This continued rotation now commences the downward power stroke of the engine 10. At a timing to be determined by an engine management system (not shown) but approximately at the time of the piston 18 commences the power stroke, a spark plug or other ignition device is operated to commence combustion of the fuel/air mixture within the combustion chamber 22. This combustion results in a rapid increase in fluid pressure within the combustion chamber 22 and drives the piston 18 in a downward stroke supplying momentum to the fly wheel coupled to the shaft 16.

During the power stroke the volume of the region 76 increases resulting in a reduction in pressure in this region causing the induction of further cool air through the filter 162, conduit 160, valve 166 and port 164 into the region 76. Simultaneously the volume of the region 78 decreases increasing fluid pressure causing compression of the previously inducted fuel/air mixture charge which now flows through the conduit 146, and the one way valve 152 into the accumulator 150. The valve 144 is closed during this process. However, a fresh charge of fuel/air mixture is unable to enter the combustion chamber 22 as the valve 30 remains closed.

Upon the piston 18 reaching BDC corresponding with the ball bearings 118 being located at the peaks P1 and P2 the final upward exhaust stroke of the combustion cycle commences. The momentum of the fly wheel continues to rotate the shaft 16 causing rotation of the piston 38. As a consequence, by action of the engagement of the track 116 with primary ball bearings 118, the piston 18 commences the upward exhaust stroke. During this stroke, the exhaust valve 32 is opened by operation of the cam shaft 34 allowing the exhaust gases to flow into the exhaust manifold 174. The volume of the region 76 commences to decrease causing an increase in pressure of air within this region which in turn closes the one way valve 166 and opens the one way valve 176 allowing this air to flow into the accumulator 170. This air is communicated to the exhaust manifold 174 via a conduit 172 thus adding fresh air to the exhaust gases. It is believed that this fresh air reacts with the exhaust gases to reduce the amount of carbon monoxide within the exhaust gases by converting the carbon monoxide to less harmful carbon dioxide.

Simultaneously, the volume of the region 78 increases causing a fresh induction of fuel/air mixture into the region 78 via the conduit 140, the one way valve 144 which is now open, the conduit 142 and the conduit 146. Thus fuel/air is charged into the accumulator 150 twice per cycle.

Once the piston 18 reaches top dead centre, the above sequence of strokes repeat ad infinitum while the engine 10 is running.

As the piston 18 reciprocates the lubricant piston 96 reciprocates within the passage 92. During an upstroke of the lubricant piston 96, oil within the region 106 is drawn into the passage 92. On the downstroke of the lubricant piston 96, the oil previously drawn into the passage 92 flows through the gallery 98 and galleries 100 flowing onto the surface of the piston head 28 and the inner circumferential surface of the cylinder 12.

Since the piston 18 is rotating while it reciprocates, the oil flowing from the galleries 100 provides a relatively uniform distribution of lubricant within the cylinder 12. Further, due to the cooling effect of the air inducted into the region 76, the oil is also cooled, further assisting in cooling of the engine 10 as cooling is effected by both the inducted air in the region 76 and the lubricant oil. In order to control the volume of oil pumped by the lubricant system, a nozzle may be attached to the end 99 of the lubricant piston 96 in fluid communication with the passage 98.

From the above description, it should be apparent to those skilled in the relevant arts that the stroke speed, stroke length, stroke period and torque output may be varied by changing the configuration of the track 116. Stroke speed in this context is the time taken for the piston 18 to traverse the distance between top dead centre and bottom dead centre. The stroke length is the distance between top dead centre and bottom dead centre. The stroke period is the angle of rotation of the piston 38 required to complete any particular stroke. The torque of the engine 10 is in effect the force exerted by the piston 18 during the power stroke applied at radius R2 about the longitudinal axis 14, where the radius R2 is the radius of the second piston 38.

The ability to vary the stroke speed and period is illustrated in FIG. 4 which shows a track 116a in which all four strokes of the otto cycle are completed in a 360° rotation (ie, a single complete rotation) of the second piston 38. However the strokes S1 and S3, being the upstrokes, have a longer period, that is require a greater degree of rotation of the piston 38 to complete than the downstrokes S2 and S4. Strokes S1 and S3 require a rotation of the piston 38 of 90+X° while the strokes S2 and S4 require a rotation of the piston 38 of 90−X°. However as the distance A between the peaks P1 and P2 and the troughs T1 and T2 is identical, the stroke length is the same for each of strokes S1-S4. Accordingly the piston 18 travels at a greater linear speed in the strokes S2 and S4 than the strokes S1 and S3. Hence as illustrated above, by changing the configuration of the track 116, the stroke speed and stroke period can be changed.

The stroke length may be changed by varying the configuration of the track 116 so that the transverse distance A between one pair of adjacent peaks and troughs is different to that of another pair of adjacent peaks and troughs. For example, the track 116 may be reconfigured so that the transverse distance between P1 and T2 is less than the transverse distance between P2 and T1.

In relation to the torque output of the engine 10, the “lever arm” provided by the radius R2 remains constant during the entire power stroke. There is no variation in the length of the lever arm as there is in a conventional crank shaft where the corresponding lever arm has a length of zero at both the top and the bottom of the power stroke. Accordingly the engine 10 is able to provide a greater and more constant torque output for the same displacement and effective stroke length of a conventional crank shaft engine. Further, torque can be increased by increasing the radius of the track 116, i.e. increasing the radius of the piston 38. This of course also requires increasing the diameter of the cylinder 12 and in particular the diameter of the portion 82 of the cylinder 12.

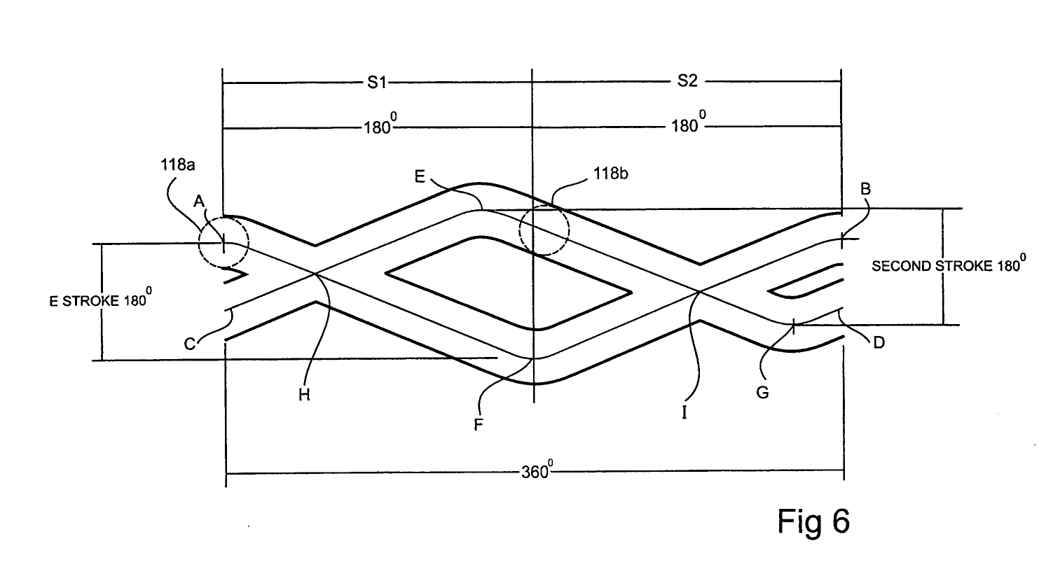

FIG. 6 depicts an alternate configuration track 116b in which one complete cycle or circuit of the track requires two rotations, ie, a 720° rotation of the piston 38. In the depicted track 116b, point A joins point B and point C joins point D.

The location of the primary ball bearing 118 is also depicted in the track 116b. Points C,E,D represent a first phase of the track 116b and points A,F,B represent a second phase of the track 116b. The track 116b is configured so that the respective primary bearings 118a and 118b are disposed in opposite phases of the track. Further, the track is configured so that the primary ball bearings 118 do not reach crossover points H and I at the same time. For example, if a piston 38 formed with track 116b were rotating an anti-clockwise direction corresponding to the track 116b moving toward the left in FIG. 7, the bearing 118a at point A would reach the crossover point H before the primary bearing 118b reaches the crossover point I. Accordingly the ball bearing 118b will act as a guide to ensure that the ball bearing 118a as it traverses the crossover point H remains in the first phase of the track 116b. In this embodiment, all four strokes are of the same period, requiring a 180° rotation of the corresponding piston 38,

Now that embodiments of the invention have been described in detail, it will be apparent to those skilled in the relevant arts that numerous modifications and variations may be made without departing from the basic inventive concepts. For example, in the engine 10 described above, a fuel/air mixture is supplied to the region 78 which is later fed to the inlet manifold 154. However in an alternate configuration, if desired a supply of air only may be provided to the region 78 via conduit 140 in which case the piston 38 in effect may also act as a compressor or supercharger providing compressed air which may be fed to the inlet manifold 154.

In that event, fuel may be provided by fuel injection into the inlet port of the cylinder head 54, or by way of direct injection into the combustion chamber 22. Further, the illustrated embodiment depicts an engine with a single cylinder only. However the engine 10 may be made with a plurality of cylinders in which the outputs of the respective shafts 16 are coupled by a gear mechanism or gearbox to drive a flywheel. In addition, a pressure relief valve or mechanism may be placed in the accumulator 150 to relieve pressure in the event that it exceeds a predetermined threshold. Relief may be via a return path to the conduit 142.

All such modifications and variations together with others that would be obvious to a person of ordinary skill in the art are deemed to be within the scope of the present invention, the nature of which is to be determined from the above description and the appended claims.

1. An internal combustion rotary piston engine comprising:
at least one cylinder having a longitudinal axis;
a power piston and a second piston retained in each cylinder, the power piston and second piston being fixed to each other;
a shaft supported coaxially in the cylinder wherein the shaft is rotatable about the longitudinal axis and fixed from translational motion along the longitudinal axis, wherein torque provided by the engine is output through the shaft;
the power piston and second piston mounted on the shaft wherein the power piston and second piston can reciprocate along the longitudinal axis and are rotationally fixed relative to the shaft; and,
a track and a bearing system coupling the second piston to the cylinder wherein as the second piston reciprocates the bearing system engages the track to cause rotation of the second piston and the shaft about the longitudinal axis, wherein the track has a radius greater than a radius of the power piston.

2. The engine according to claim 1 wherein the engine is configured to operate on a four stroke cycle comprising an induction stroke, a compression stroke, a power stroke and an exhaust stroke with respective sequential reciprocations of the power piston along the shaft.

3. The engine according to claim 2 wherein the four stroke cycle is completed with a 360 degree rotation of the shaft.

4. The engine according to claim 3 wherein during the power stroke the power piston and the shaft rotate by 90 degrees about the longitudinal axis.

5. The engine according to claim 4 wherein the power piston rotates by 90 degrees during each of the induction, compression and exhaust strokes.

6. The engine according to claim 3 wherein the power stroke has a period Pp, and the exhaust stroke has a period Pe wherein Pp>Pe.

7. The engine according to claim 3 wherein the induction stroke has a period Pi and a compression stroke has a period Pc wherein Pi>Pc.

8. The engine according to claim 1 wherein the cylinder comprises a compression region located between the second piston and an end of the cylinder distant the power piston; and a first fluid flow path providing fluid communication between the compression region and a combustion chamber formed between the power piston and an adjacent end of the cylinder enabling fluid compressed in the compression region to flow to the combustion chamber.

9. The engine according to claim 8 comprising a first inlet to the first fluid flow path wherein fluid from the first inlet flows through the first fluid path to the compression region during an upstroke of the piston.

10. The engine according to claim 9 wherein the fluid is air or a fuel and air mixture.

11. The engine according to claim 8 comprising a first valve for controlling induction of the fluid into the compression region wherein during an upstroke of the power piston a relative of vacuum is created in the compression region to open the first one way valve and induct the fluid into the compression region, and wherein on a downstroke of the power piston, the second piston compresses the fluid and creates a relative positive pressure closing the first one way valve.

12. The engine according to claim 11 comprising a second valve for controlling flow of compressed fluid from the compression region to the combustion chamber, wherein the second one way valve closes when the power piston travels in an upstroke and opens during a downstroke of the power piston.

13. The engine according to claim 1 wherein the cylinder comprises:
a cooling region between the power piston and the second piston and, a port in the cylinder enabling a gas to flow into the cooling region during a downstroke of the power piston and out of the cooling region during an upstroke of the power piston.

14. The engine according to claim 13 comprising a second fluid flow path between the port and an exhaust manifold wherein the gas flowing out of the cooling region can flow through the second flow path into the exhaust manifold.

15. The engine according to claim 13 comprising a third one way valve for controlling flow of the gas into the cooling region, the third one way valve opening during a downstroke of the power piston to induct a flow of the gas into the cooling region to cool the cylinder and power piston.

16. The engine according to claim 15 comprising a fourth one way valve, the fourth one way valve being provided in the second fluid flow path and which opens during a upstroke of the power piston and closes during an downstroke of the power piston, the fourth one way valve opening the second fluid flow path between the cooling region and an exhaust wherein the gas previously inducted in the cooling region is exhausted to the exhaust manifold.

17. The engine according to claim 1 wherein the coupling system comprises either (a) an endless track formed about an outer circumferential surface of the second piston and a bearing system supported by the cylinder that engages the track, or (b) an endless track formed on a surface of the cylinder and a bearing system supported by the second piston that engages the track.

18. The engine according to claim 17 wherein the bearing system comprises:
a primary ball bearing and a plurality of secondary ball bearings on which the primary ball bearing sits; and,
a spacer system for spacing the secondary ball bearings from each other;
wherein the primary ball bearing has a radius greater than a radius of the secondary ball bearings.

19. The engine according to claim 18 wherein the spacer system comprises a plurality of tertiary ball bearings wherein the tertiary ball bearings have a radius less than a radius of the secondary ball bearings.

20. The engine according to claim 19 comprising a cup having a bearing surface on which the secondary ball bearings run.

21. The engine according to claim 20 wherein the tertiary ball bearings are located between respective secondary ball bearings on a side adjacent to the bearing surface.

22. The engine according to claim 20 wherein the tertiary ball bearings are disposed between adjacent secondary ball bearings on a side opposite the bearing surface and adjacent to the primary ball bearing.

23. The engine according to claim 20 wherein the plurality of tertiary ball bearings may comprise first and second sets of tertiary ball bearings wherein the first set of tertiary ball bearings are disposed on a side of the secondary ball bearings adjacent the bearing surface and a second set of the tertiary ball bearings are disposed on a side of the secondary ball bearings adjacent the primary ball bearings.

24. The engine according to claim 1 comprising a lubrication system which distributes a lubricant to an interior of the cylinder, the lubricant system comprising a passage extending axially within the shaft, the passage providing a fluid communication path between a supply of lubricant and the interior of the cylinder.

25. The engine according to claim 24 wherein the lubrication system comprises a lubricant piston disposed in the passage, the lubricant piston coupled to the power piston and reciprocating in the passage as the power piston reciprocates in the cylinder. A lubricant outlet is provided at an end of the passage opening onto an outer circumferential surface of the power piston and to cylinder walls.

26. A bearing system comprising:
a primary ball bearing and a plurality of secondary ball bearings on which the primary ball bearing sits; and,
a spacer system for spacing the secondary ball bearings from each other the spacer system comprising a plurality of tertiary ball bearings;
wherein the primary ball bearing has a radius greater than a radius of the secondary ball bearing, and a radius of each tertiary ball bearing is smaller than the radius of each secondary ball bearing.

27. The bearing system according to claim 26 comprising a bearing surface on which the secondary ball bearings sit and wherein the tertiary ball bearings are located between the secondary ball bearings on a side and adjacent the bearing surface.

28. The bearing system according to claim 26 comprising a bearing surface on which the secondary ball bearings sit and wherein the tertiary ball bearings are located between the secondary ball bearings on a side adjacent the primary bearing.

29. The bearing system according to claim 26 comprising a bearing surface on which the secondary ball bearings sit and wherein the tertiary ball bearings are located between the secondary ball bearings on each of a side adjacent the bearing surface and a side adjacent the primary bearing.
